(19) United States
(12) Patent Application Publication
(10) Pub. No.: US 2023/0247128 A1
(43) Pub. Date: Aug. 3, 2023

(54) Two Way Messaging Assembly

(71) Applicant: Taylor Hamilton, Naples, FL (US)

(72) Inventor: Taylor Hamilton, Naples, FL (US)

(21) Appl. No.: 17/591,731

(22) Filed: Feb. 3, 2022

(51) Int. Cl. H04M 1/72433; H04M 3/533

(52) U.S. Cl. CPC H04M 1/72433; H04M 3/53375

(57) ABSTRACT

A two way messaging assembly for facilitating brief, recorded messages to be exchanged includes a pair of messaging units that is each in wireless communication with each other. Each of the messaging units is actuatable into a recording condition for recording a spoken message and each of the messaging units is actuatable into a playback condition for playing back a previously recorded spoken message. The messaging units broadcast the spoken message to each other to facilitate a pair of users to remotely communicate with each other. Each of the messaging units has an indicator to alert the user to listen to the spoken message.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to messaging devices and more particularly pertains to a new messaging device for facilitating brief, recorded messages to be exchanged. The device includes a pair of messaging units that are in wireless communication with each other. Each of the messaging units can be actuated to record a brief verbal message and to subsequently broadcast the brief verbal message to the other messaging unit. In this way the brief verbal message sent from one messaging unit can be played back on the other messaging unit, and vice versa.

### (2) Description of Related Art Including Information Disclosed Under 37 CFR 1.97 and 1.98

The prior art relates to messaging devices a remote phone call screening device for remotely listening to an incoming phone call. The prior art discloses a messaging system to facilitate a visitor to leave a recorded voice message for an occupant of the building. The prior art discloses a transceiver with a message received indicator. The prior art discloses an ornamental design for a speaker light emitter ring.

### (h) BRIEF SUMMARY OF THE INVENTION

An embodiment of the disclosure meets the needs presented above by generally comprising a pair of messaging units that is each in wireless communication with each other. Each of the messaging units is actuatable into a recording condition for recording a spoken message and each of the messaging units is actuatable into a playback condition for playing back a previously recorded spoken message. The messaging units broadcast the spoken message to each other to facilitate a pair of users to remotely communicate with each other. Each of the messaging units has an indicator to alert the user to listen to the spoken message.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a two way messaging assembly according to an embodiment of the disclosure.

FIG. 2 is a bottom perspective view of an embodiment of the disclosure.

FIG. 3 is a right side view of an embodiment of the disclosure.

FIG. 4 is a bottom view of an embodiment of the disclosure.

FIG. 5 is a schematic view of an embodiment of the disclosure.

FIG. 6 is a perspective in-use view of an embodiment of the disclosure.

### (j) DETAILED DESCRIPTION OF THE INVENTION

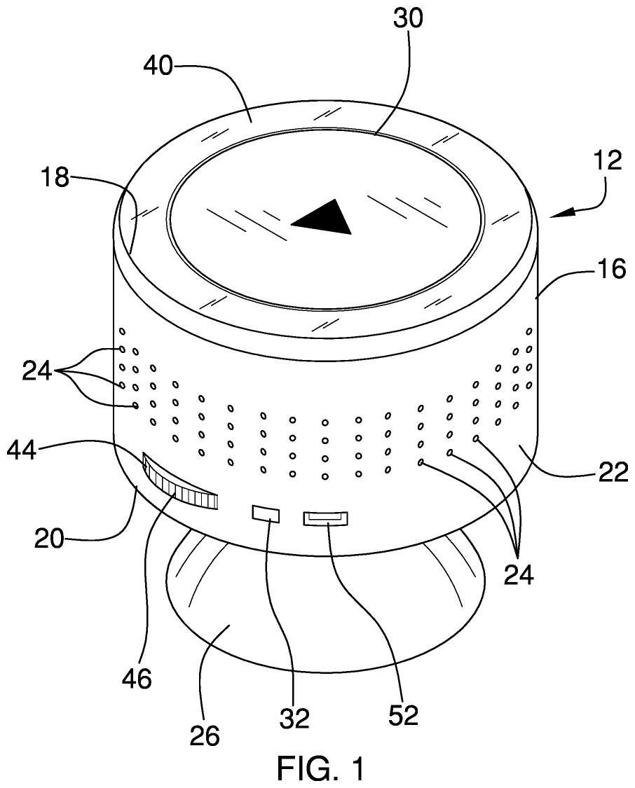

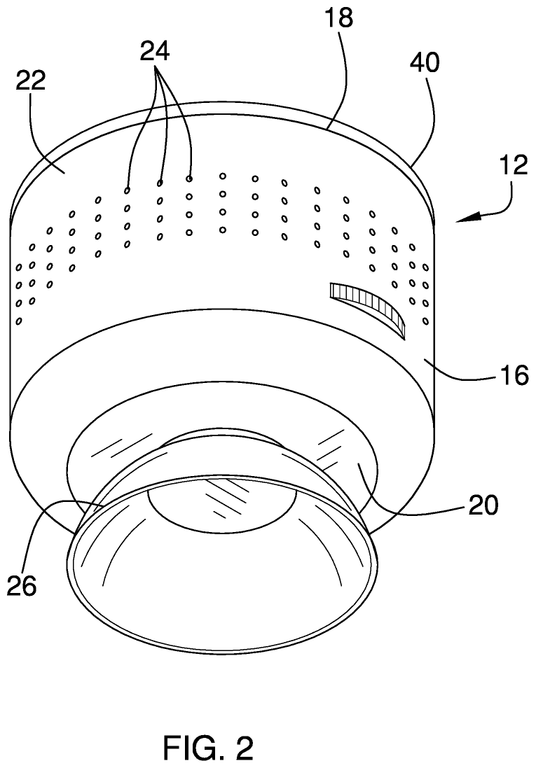

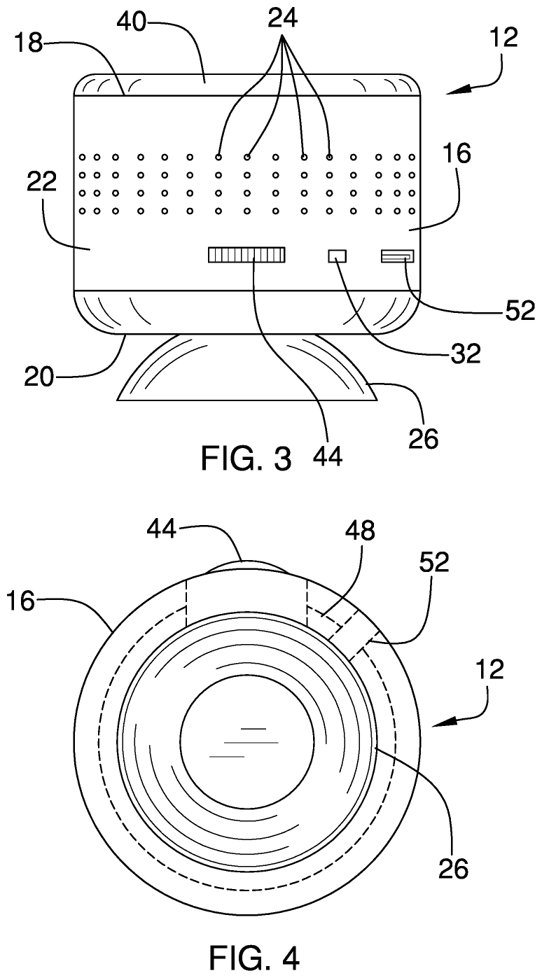

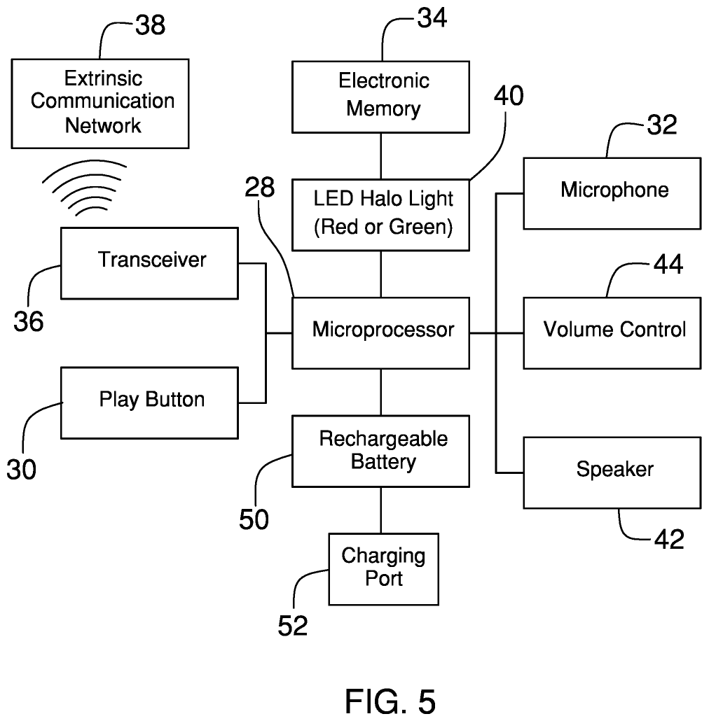

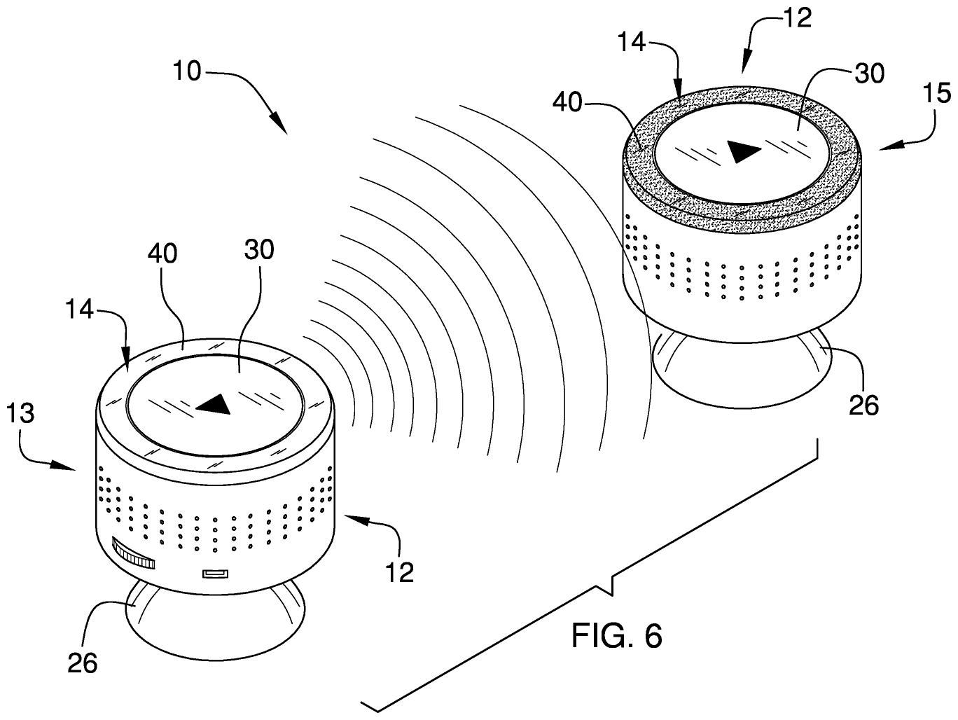

With reference now to the drawings, and in particular to FIGS. 1 through 6 thereof, a new messaging device embodying the principles and concepts of an embodiment of the disclosure and generally designated by the reference numeral 10 will be described.

As best illustrated in FIGS. 1 through 6, the two way messaging assembly 10 generally comprises a pair of messaging units 12 and each of the messaging units 12 is in wireless communication with each other. Each of the messaging units 12 is actuatable into a recording condition for recording a spoken message. Additionally, each of the messaging units 12 is actuatable into a playback condition for playing back a previously recorded spoken message. The messaging units 12 broadcast the spoken message to each other to facilitate a pair of users to remotely communicate with each other. Each of the messaging units 12 has an indicator 14 that is actuatable into a first condition to indicate a spoken message has been received. In this way the indicator 14 alerts the user to listen to the spoken message. The indicator 14 on each of the messaging units 12 is actuatable into a second condition to indicate no spoken message has been received. The pair of messaging units 12 includes a first messaging unit 13 and a second messaging unit 15.

Each of the messaging units 12 comprises a housing 16 has a top wall 18, a bottom wall 20 and an outer wall 22 extending between the outer wall 22 and the bottom wall 20. The outer wall 22 is continuously arcuate about an axis extending between the top wall 18 and the bottom wall 20 such that the housing 16 has a cylindrical shape. The outer wall 22 has a plurality of speaker holes 24 each extending into an interior of the housing 16 and the speaker holes 24 are arranged into a plurality of rings extending around a full circumference of the outer wall 22. Each of the messaging units 12 includes a cup 26 that is attached to and extends away from the bottom wall 20 of the housing 16. The cup 26 is comprised of a deformable material such that the cup 26 can be compressed against a surface to suctionally engage the surface.

Each of the messaging units 12 includes a control circuit 28 that is integrated into the housing 16. The control circuit 28 receives a message input, the control circuit 28 receives a record input and the control circuit 28 receives a playback input. A control button 30 is movably integrated into the top wall 18 of the housing 16 and the control button 30 is electrically coupled to the control circuit 28. The control circuit 28 receives the record input when the control button 30 is depressed and the control circuit 28 has not received the message input. Additionally, the control circuit 28 receives the playback input when the control button 30 is depressed and the control circuit 28 has received the message input.

Each of the messaging units 12 includes a microphone 32 that is integrated into the housing 16 such that the microphone 32 can capture audible sounds. The microphone 32 is electrically coupled to the control circuit 28 and the microphone 32 is turned on when the control circuit 28 receives the record input. The microphone 32 may comprise an electronic microphone 32 of any conventional design. Each of the messaging units 12 includes an electronic memory 34 which is integrated into the housing 16. The electronic memory 34 is electrically coupled to the control circuit 28 and the electronic memory 34 stores data comprising a spoken message captured by the microphone 32.

Each of the messaging units 12 includes a transceiver 36 which is integrated into the housing 16 and the transceiver 36 is electrically couped to the control circuit 28. The transceiver 36 broadcasts the data in the electronic memory 34 when the data is downloaded into the electronic memory 34. The transceiver 36 associated with the first messaging unit 13 is in remote communication with the transceiver 36 associated with the second messaging unit 15. Furthermore, the transceiver 36 in the first messaging unit 13 receives the data from the transceiver 36 in the second massage unit, and the transceiver 36 in the second messaging unit 15 receives the data from the transceiver 36 in the first messaging unit 13. The transceiver 36 in each of the messaging units 12 may comprise a radio frequency transceiver or the like. Additionally, transceiver 36 in each of the messaging units 12 may be in wireless communication with an extrinsic communication network 38 such as the internet or the like. In this way the pair of messaging units 12 can be in communication with each other over a nearly unlimited distance.

The control circuit 28 associated with the first messaging unit 13 receives the message input when the transceiver 36 in the first messaging unit 13 receives the data from the transceiver 36 in the second messaging unit 15. Additionally, the data broadcast from the transceiver 36 in the second messaging unit 15 is stored in the electronic memory 34 associated with the first messaging unit 13. The control circuit 28 associated with the second messaging unit 15 receives the message input when the transceiver 36 in the second messaging unit 15 receives the data from the transceiver 36 in the first messaging unit 13. Further, the data broadcast from the transceiver 36 in the first messaging unit 13 is stored in the electronic memory 34 associated with the second messaging unit 15.

A light emitter 40 is integrated into the top wall 18 such that light emitter 40 can emit light outwardly from the top wall 18, and in this way the light emitter 40 defines the indicator 14 on the message unit. The light emitter 40 is electrically coupled to the control circuit 28, and the light emitter 40 is actuated to emit a first color of light when the control circuit 28 has not received the message input. Furthermore, the light emitter 40 is actuated to emit a second color of light when the control circuit 28 has received the message input. The first color of light may be red and the second color of light may be green. Furthermore, the light emitter 40 surrounds the control button 30 on the top wall 18 such that the light emitter 40 defines a closed ring on the top wall 18. The light emitter 40 may comprise a light emitting diode or other type of electronic light emitter.

Each of the messaging units 12 includes a speaker 42 that is positioned within the housing 16 to emit aubible sounds outwardly through the plurality of speaker holes 24. The speaker 42 is electrically coupled to the control circuit 28 and the speaker 42 receives the data from the transceiver 36 to facilitate a user to listen to the spoken message. Each of the messaging units 12 includes a volume wheel 44 that is rotatably integrated into the outer wall 22 of the housing 16. The volume wheel 44 has a perimeter edge 46 which extends outwardly through the outer wall 22 such that the perimeter edge 46 can be manipulated by the user. The volume wheel 44 adjusts a volume of the speaker 42 between a minimum volume and a maximum volume.

A power supply 48 is integrated into the housing 16 and the power supply 48 is electrically coupled to the control circuit 28. The power supply 48 comprises a rechargeable battery 50 that is integrated into the housing 16 and the rechargeable battery 50 is electrically coupled to the control circuit 28. The power supply 48 includes a charge port 52 that is recessed into the outer wall 22 of the housing 16 to receive a charge cord 54. The charge port 52 is electrically coupled to the rechargeable battery 50 for charging the rechargeable battery 50.

In use, the control button 30 on the first messaging unit 13 is depressed to record a verbal message and to subsequently broadcast the verbal message to the second messaging unit 15. The light emitter 40 on the second messaging unit 15 emits the second color of light to communicate that a message has been received. The control button 30 on the second messaging unit 15 is depressed to playback the verbal message. Conversely, the control button 30 on the second messaging unit 15 is depressed to record a verbal message and to subsequently broadcast the verbal message to the first messaging unit 13. The light emitter 40 on the first messaging unit 13 emits the second color of light to communicate that a message has been received. The control button 30 on the first messaging unit 13 is depressed to playback the verbal message. In this way two people that are apart can relay brief messages back and forth to each other without the use of a smart phone or other similar type of personal electronic device.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A two way messaging assembly for recording and playing back a voice message, said assembly comprising:
a pair of messaging units, each of said messaging units being in wireless communication with each other, each of said messaging units being actuatable into a recording condition for recording a spoken message, each of said messaging units being actuatable into a playback condition for playing back a previously recorded spoken message, said messaging units broadcasting said spoken message to each other wherein said message units are configured to facilitate a pair of users to remotely communicate with each other, each of said messaging units having an indicator, said indicator on each of said messaging units being actuatable into a first condition to indicate a spoken message has been received wherein said indicator is configured to alert the user to listen to the spoken message, said indicator on each of said messaging units being actuatable into a second condition to indicate no spoken message has been received.

2. The assembly according to claim 1, wherein each of said messaging units comprising a housing having a top wall, a bottom wall and an outer wall extending between said outer wall and said bottom wall, said outer wall being continuously arcuate about an axis extending between said top wall and said bottom wall such that said housing has a cylindrical shape, said outer wall having a plurality of speaker holes each extending into an interior of said housing, said speaker holes being arranged into a plurality of rings extending around a full circumference of said outer wall.

3. The assembly according to claim 2, wherein each of said messaging units includes:
a control circuit being integrated into said housing, said control circuit receiving a message input, said control circuit receiving a record input, said control circuit receiving a playback input; and
a control button being movably integrated into said top wall of said housing, said control button being electrically coupled to said control circuit, said control circuit receiving said record input when said control button is depressed and said control circuit has not received said message input, said control circuit receiving said playback input when said control button is depressed and said control circuit has received said message input.

4. The assembly according to claim 3, wherein each of said messaging units includes a microphone being integrated into said housing wherein said microphone is configured to capture audible sounds, said microphone being electrically coupled to said control circuit, said microphone being turned on when said control circuit receives said record input.

5. The assembly according to claim 4, wherein each of said messaging units includes an electronic memory being integrated into said housing, said electronic memory being electrically coupled to said control circuit, said electronic memory storing data comprising a spoken message captured by said microphone.

6. The assembly according to claim 5, wherein:
said pair of messaging units includes a first messaging unit and a second messaging unit; and
each of said messaging units includes a transceiver being integrated into said housing, said transceiver being electrically couped to said control circuit, said transceiver broadcasting said data in said electronic memory when said data is downloaded into said electronic memory, said transceiver in said associated with said first message unit being in remote communication with said transceiver associated with said second message unit, said transceiver in said first message unit receiving said data from said transceiver in said second massage unit, said transceiver in said second message unit receiving said data from said transceiver in said first message unit, said control circuit associated with said first message unit receiving said message input when said transceiver in said first message unit receives said data from said transceiver in said second message unit thereby facilitating said data to be stored in said electronic memory associated with said first message unit, said control circuit associated with said second message unit receiving said message input when said transceiver in said second message unit receives said data from said transceiver in said first message unit thereby facilitating said data to be stored in said electronic memory associated with said second message unit.

7. The assembly according to claim 3, wherein each of said messaging units includes a light emitter being integrated into said top wall wherein light emitter is configured to emit light outwardly from said top wall, said light emitter defining said indicator on said message unit, said light emitter being electrically coupled to said control circuit, said light emitter being actuated to emit a first color of light when said control circuit has not received said message input, said light emitter being actuated to emit a second color of light when said control circuit has received said message input, said light emitter surrounding said control button on said top wall such that said light emitter defines a closed ring on said top wall.

8. The assembly according to claim 3, wherein each of said messaging units includes a speaker being positioned within said housing wherein said speaker is configured to emit aubible sounds outwardly through said plurality of speaker holes, said speaker being electrically coupled to said control circuit, said speaker receiving said data from said transceiver wherein said speaker is configured to facilitate a user to listen to the spoken message.

9. The assembly according to claim 8, wherein each of said messaging units includes a volume wheel being rotatably integrated into said outer wall of said housing, said volume knob having a perimeter edge extending outwardly through said outer wall wherein said perimeter edge is configured to be manipulated by the user, said volume knob adjusting a volume of said speaker between a minimum volume and a maximum volume.

10. The assembly according to claim 3, wherein each of said messaging units includes a power supply being integrated into said housing, said power supply being electrically coupled to said control circuit, said power supply comprising:
a rechargeable battery being integrated into said housing, said rechargeable battery being electrically coupled to said control circuit; and
a charge port being recessed into said outer wall of said housing wherein said charge port is configured to receive a charge cord, said charge port being electrically coupled to said rechargeable battery for charging said rechargeable battery.

11. A two way messaging assembly for recording and playing back a voice message, said assembly comprising:
a pair of messaging units, each of said messaging units being in wireless communication with each other, each of said messaging units being actuatable into a recording condition for recording a spoken message, each of said messaging units being actuatable into a playback condition for playing back a previously recorded spoken message, said messaging units broadcasting said spoken message to each other wherein said message units are configured to facilitate a pair of users to remotely communicate with each other, each of said messaging units having an indicator, said indicator on each of said messaging units being actuatable into a first condition to indicate a spoken message has been received wherein said indicator is configured to alert the user to listen to the spoken message, said indicator on each of said messaging units being actuatable into a second condition to indicate no spoken message has been received, said pair of messaging units including a first messaging unit and a second messaging unit, each of said messaging units comprising:
a housing having a top wall, a bottom wall and an outer wall extending between said outer wall and said bottom wall, said outer wall being continuously arcuate about an axis extending between said top wall and said bottom wall such that said housing has a cylindrical shape, said outer wall having a plurality of speaker holes each extending into an interior of said housing, said speaker holes being arranged into a plurality of rings extending around a full circumference of said outer wall;
a control circuit being integrated into said housing, said control circuit receiving a message input, said control circuit receiving a record input, said control circuit receiving a playback input;
a control button being movably integrated into said top wall of said housing, said control button being electrically coupled to said control circuit, said control circuit receiving said record input when said control button is depressed and said control circuit has not received said message input, said control circuit receiving said playback input when said control button is depressed and said control circuit has received said message input;
a microphone being integrated into said housing wherein said microphone is configured to capture audible sounds, said microphone being electrically coupled to said control circuit, said microphone being turned on when said control circuit receives said record input;
an electronic memory being integrated into said housing, said electronic memory being electrically coupled to said control circuit, said electronic memory storing data comprising a spoken message captured by said microphone;
a transceiver being integrated into said housing, said transceiver being electrically couped to said control circuit, said transceiver broadcasting said data in said electronic memory when said data is downloaded into said electronic memory, said transceiver in said associated with said first message unit being in remote communication with said transceiver associated with said second message unit, said transceiver in said first message unit receiving said data from said transceiver in said second massage unit, said transceiver in said second message unit receiving said data from said transceiver in said first message unit, said control circuit associated with said first message unit receiving said message input when said transceiver in said first message unit receives said data from said transceiver in said second message unit thereby facilitating said data to be stored in said electronic memory associated with said first message unit, said control circuit associated with said second message unit receiving said message input when said transceiver in said second message unit receives said data from said transceiver in said first message unit thereby facilitating said data to be stored in said electronic memory associated with said second message unit;
a light emitter being integrated into said top wall wherein light emitter is configured to emit light outwardly from said top wall, said light emitter defining said indicator on said message unit, said light emitter being electrically coupled to said control circuit, said light emitter being actuated to emit a first color of light when said control circuit has not received said message input, said light emitter being actuated to emit a second color of light when said control circuit has received said message input, said light emitter surrounding said control button on said top wall such that said light emitter defines a closed ring on said top wall;
a speaker being positioned within said housing wherein said speaker is configured to emit aubible sounds outwardly through said plurality of speaker holes, said speaker being electrically coupled to said control circuit, said speaker receiving said data from said transceiver wherein said speaker is configured to facilitate a user to listen to the spoke message;
a volume wheel being rotatably integrated into said outer wall of said housing, said volume knob having a perimeter edge extending outwardly through said outer wall wherein said perimeter edge is configured to be manipulated by the user, said volume knob adjusting a volume of said speaker between a minimum volume and a maximum volume; and
a power supply being integrated into said housing, said power supply being electrically coupled to said control circuit, said power supply comprising:
a rechargeable battery being integrated into said housing, said rechargeable battery being electrically coupled to said control circuit; and
a charge port being recessed into said outer wall of said housing wherein said charge port is configured to receive a charge cord, said charge port being electrically coupled to said rechargeable battery for charging said rechargeable battery.
